(19) United States
(12) Patent Application Publication
(10) Pub. No.: US 2004/0187856 A1
(43) Pub. Date: Sep. 30, 2004

(54) Thin stone cutting machine, method, and product

(75) Inventors: Thomas L. Schlough, St. Cloud, MN (US); Phillip Arthur Snartland, St. Cloud, MN (US)

Correspondence Address: Merchant & Gould P.C., P.O. Box 2903, Minneapolis, MN, 55402-0903, US

(73) Assignee: Park Industries, Inc.

(21) Appl. No.: 10/757,608

(22) Filed: Jan. 13, 2004

Related U.S. Application Data
(60) Provisional application No. 60/458,883, filed on Mar. 28, 2003.

(51) Int. Cl. B28D 1/02

(52) U.S. Cl. 125/13.01

(57) ABSTRACT

A thin stone cutting apparatus and method includes a groove cutting device for cutting a groove in a side of a block of stone along a first cutting plane. A block cutting device cuts each block of stone in a direction from an opposite side of the block. A block cutting device cuts each block along a second cutting plane co-planar with the first cutting plane. Alternatively, the first and second cutting planes of the groove cutting device and the block cutting device can be at different angles to one another. A block holder device includes a linear member received in a groove of each block when each block is being cut by the block cutting device. A conveyor is provided for moving each block relative to the block cutting device where the linear member of the block holder device is mounted to the conveyor. Alternatively, the block cutting device is moveable relative to the block holder device. The resulting stone includes a rock body made from natural stone and having a front, and an opposite facing back. A protruding linear ridge extends from the back of the rock body. A plurality of the thin stones can be assembled to form a wall wherein the mortar holds the thin stones to a vertical surface wherein the linear ridges of the thin stones protrude into the mortar.

### CROSS REFERENCE TO RELATED APPLICATIONS

This application claims the benefit of provisional application Ser. No. 60/458,883, entitled THIN STONE CUTTING MACHINE filed on Mar. 28, 2003.

### FIELD OF THE INVENTION

This invention relates generally to machines and methods for cutting veneer building stones from material such as, but not limited to, limestone, granite, sandstone or the like, and more particularly relates to method and apparatus for cutting thin slabs from stone blocks.

### BACKGROUND OF THE INVENTION

Decorative stone in the form of thin veneer is often used as facing on homes or other buildings. The stone usually has a decorative or irregular natural side facing outwardly and is laid up along the side of a building generally in the same manner as if bricks were used. The stone may be provided to the machine as quarried or preprocessed from larger blocks into various shapes and sizes to match the maximum size capability of the machine. The face of a typical block may measure 8×10 inches, although they may be larger or smaller to provide a pleasing pattern of different sized and/or shaped blocks on the face of the building.

Conventional natural stone veneer is usually 4 to 5 inches thick which means they are quite heavy making them difficult to handle, hard to lay up, expensive to ship as well as requiring a more extensive foundation. Thinner material (from ¾ to 1½″) overcomes the above mentioned drawbacks to using conventional natural stone.

### SUMMARY OF THE INVENTION

The present invention relates to methods and apparatus for quickly and easily cutting relatively thin slabs from thicker stone material with the cut being in a plane parallel to the front face of the block and spaced a desired distance therefrom, resulting in much thinner pieces that can be used for cladding exterior or interior walls, fireplaces or for landscaping. The method includes cutting a guide groove or slot in the stone block in the desired plane of the final cut and then positioning the stone block on a conveyer comprising a series of flat fins extending into the guide slot to carry the blocks along the conveyer into the path of one or more circular stone cutting saws rotating in a direction that applies force downward on the stone and conveyor resulting in the stone held by the fins. The same result can be obtained by placing the block on a stationary rail extending into the guide slot and moving one or more circular stone sawing blades rotating and traveling in the proper direction. In either case the saws cut into the block from the side opposite the guide groove and in the same plane as the guide groove resulting in the block being cut into two pieces, one being a thinner piece including the desired front face.

One aspect of the present invention includes a stone cutting apparatus including a groove cutting device for cutting a groove in a first side of each block of stone along a first cutting plane, and a block cutting device for cutting each block of stone in a direction from a second side of the block opposite to the first side. The block cutting device cuts each block along a second cutting plane co-planar with the first cutting plane. The stone cutting apparatus includes a block holder device including a linear member received into the groove of each block when each block is being cut by the block cutting device.

A further aspect of the present invention concerns a method of cutting blocks of stone comprising the steps of: cutting a groove in each block of stone; engaging the groove with a linear member to hold the block of stone; and cutting each of the held blocks of stone from an opposite side of the stone, wherein the cut from the opposite side meets, or nearly meets, the lower groove to separate the block into two pieces.

Another aspect of the present invention relates to thin stones and a resulting wall wherein each thin stone includes a rock body made from natural stone and having a front, and opposite facing back, and a side between the front and the back. A protruding linear ridge extends from the back of the rock body. The wall includes a backing defining a vertical surface, a layer of mortar held by the backing, and a plurality of the thin stones, wherein the backs of each rock body are held by the mortar with the linear ridges protruding into the mortar.

A further aspect of the invention relates to an apparatus and method where a first groove is cut by a groove cutting device. A projecting member projects into the groove to hold the block of stone. A cutting device cuts the block with a second cut while the block is held by the projecting member. The second cut can be co-planar with the first cut, or differently oriented.

### DESCRIPTION OF THE DRAWINGS

FIG. 1 is top plan view of the stone cutting machines including a pair of basically identical stations for cutting the initial guide groove, and a final cutting station including an elongated conveyer and a plurality of circular cutting saws disposed above the conveyer;

FIG. 2 is a top plan view of the same machines shown in FIG. 1 positioned in a different relationship;

FIG. 3 is an enlarged end view of one of the groove cutting machines taken from the right side of FIG. 1;

FIG. 4 is a view in side elevation of the final cutting machine shown in FIG. 1;

FIG. 5 is an enlarged fragmentary view of the conveyer shown in FIG. 4, with a stone block being positioned on the conveyer;

FIG. 6 is an enlarged end view of the machine shown at the top of FIG. 1, taken from the right-hand side thereof;

FIG. 7 is an enlarged end view of the machine shown at the top of FIG. 1, taken from the left-hand side of the figure;

FIG. 8 is an enlarged fragmentary view of a portion of FIG. 7, showing the final cut of the block;

FIG. 9 is an enlarged top plan view of the roller conveyer shown in FIG. 1, with a pair of stone blocks having guide grooves cut therein positioned on the table;

FIG. 10 is an enlarged, fragmentary top plan view of the final cutting machine with a pair of stone blocks having guide grooves cut therein and positioned under the saw blades of the final cutting machine;

FIG. 11 is an enlarged fragmentary view of the roller conveyor between the groove cutting machines and the stone cutting and conveying machine for the arrangement of FIG. 2, with a pair of stone blocks having guide grooves cut therein positioned on the surface;

FIG. 12 is a top view of the roller conveyor of FIG. 11 with the pair of stone blocks having the guide grooves cut therein;

FIG. 13 is an end view of the roller conveyor of FIG. 11;

FIG. 14 is a view in side elevation of an alternative final cutting machine;

FIG. 15 is a top view of the cutting machine of FIG. 14;

FIG. 16 is an end view of the cutting machine of FIG. 14;

FIG. 17 is a side elevation of a portion of one of the saws in the machine of FIG. 14;

FIG. 18 is an end view of the saw of FIG. 17;

FIG. 19 is a view in side elevation of an end of an alternative conveyor with fins, showing a splitting wedge positioned to split a stone following the last saw cut;

FIG. 20 is a top view of the alternative conveyor of FIG. 19.

FIG. 21 is an enlarged end view of an alternative groove cutting machine;

FIG. 22 is an enlarged side elevation view of the groove cutting machine of FIG. 21;

FIG. 23 is a top view of the groove cutting machine of FIG. 21;

FIG. 24 is a top view of two groove cutting machines of the type shown in FIG. 21 positioned back to back for use by one or two operators;

FIG. 25 is a side view of a gantry saw which moves the saw linearly relative to stationary blocks of stone;

FIG. 26 is an end view of the gantry saw of FIG. 25;

FIG. 27 is an enlarged end view of the cutting blade and linear member holding the blocks of stone in FIG. 26;

FIG. 28 is an end view of an alternative gantry saw, with a linear member positioned at a variable angle relative to the cutting blade;

FIG. 29 is an enlarged end view of the cutting blade and the linear member holding the blocks of stone in FIG. 28;

FIG. 30 is a portion of a wall including the thin stones of the present invention;

FIG. 31 is a cross-sectional view of a portion of the wall of FIG. 30;

FIG. 32 is a back view of one of the thin stones of the wall of FIG. 30; and

FIG. 33 is an end view of the stone of FIG. 32.

### DESCRIPTION OF THE PREFERRED EMBODIMENTS

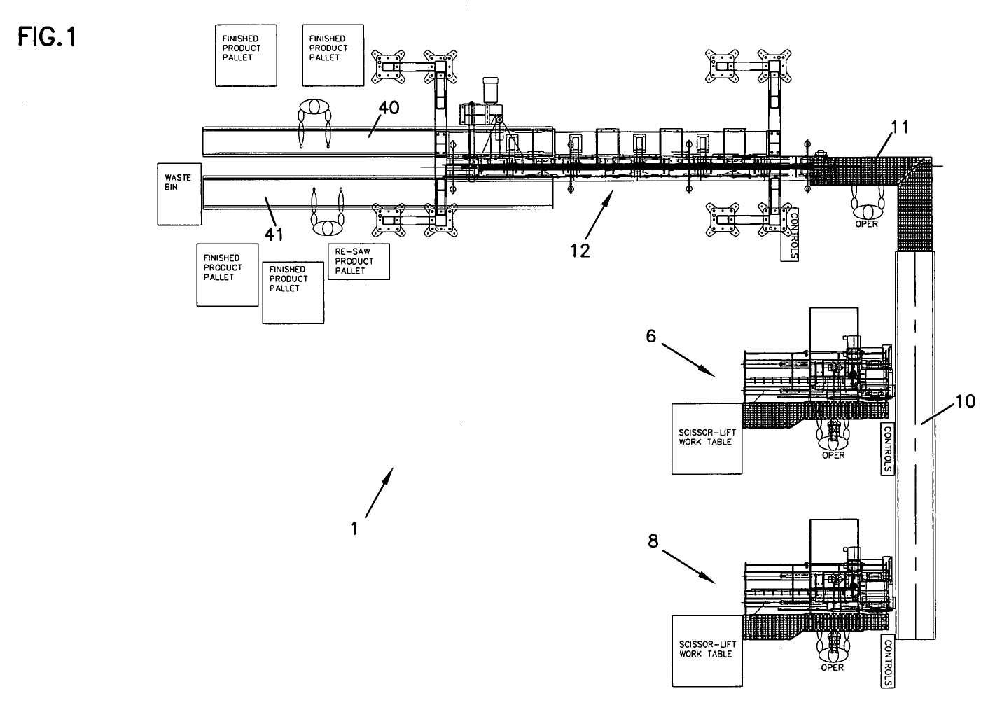

Referring to FIG. 1, system 1 produces thin stones by cutting the thin stones from larger blocks. Preferably, one of the faces of the thin stone has a natural stone texture. The thin stone is formed in two steps, (1) a groove cutting step, and (2) a final cutting step.

The resulting thin stones, created by one preferred method where the two cuts are co-planar, include linear ridges on the back surfaces of the stones. The linear ridge on each stone is formed where the two cuts come together. When used in a wall, the linear ridges provide increased surface area for joining to the mortar. Also, the linear ridges provide increased surfaces to improve shear strength.

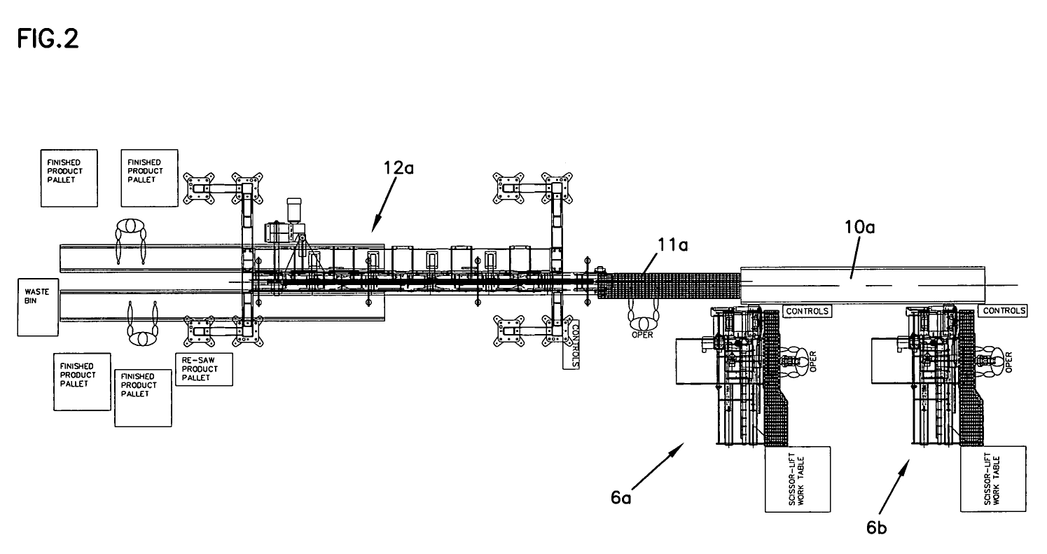

A pair of initial slot or groove cutting machines 6 and 8, of basically the same construction, are shown in FIG. 1. More or fewer of these groove cutting machines can be employed, depending on the desired rate of production. These groove cutting machines 6 and 8 are positioned adjacent a belt conveyer 10 which carries the blocks to a right-angle roller table 11 positioned to permit an operator to easily move blocks on to an elongated stone cutting and conveyer machine 12. FIG. 2 discloses another arrangement in which the groove cutting machines 6a and 8a are positioned along a belt conveyer 10a which leads directly in line to a roller conveyer 11a which in turn is in line with the stone cutting and conveying machine 12a. The machines are basically the same but are arranged so that the blocks move in a straight line from the groove cutting machines to the final cutting area.

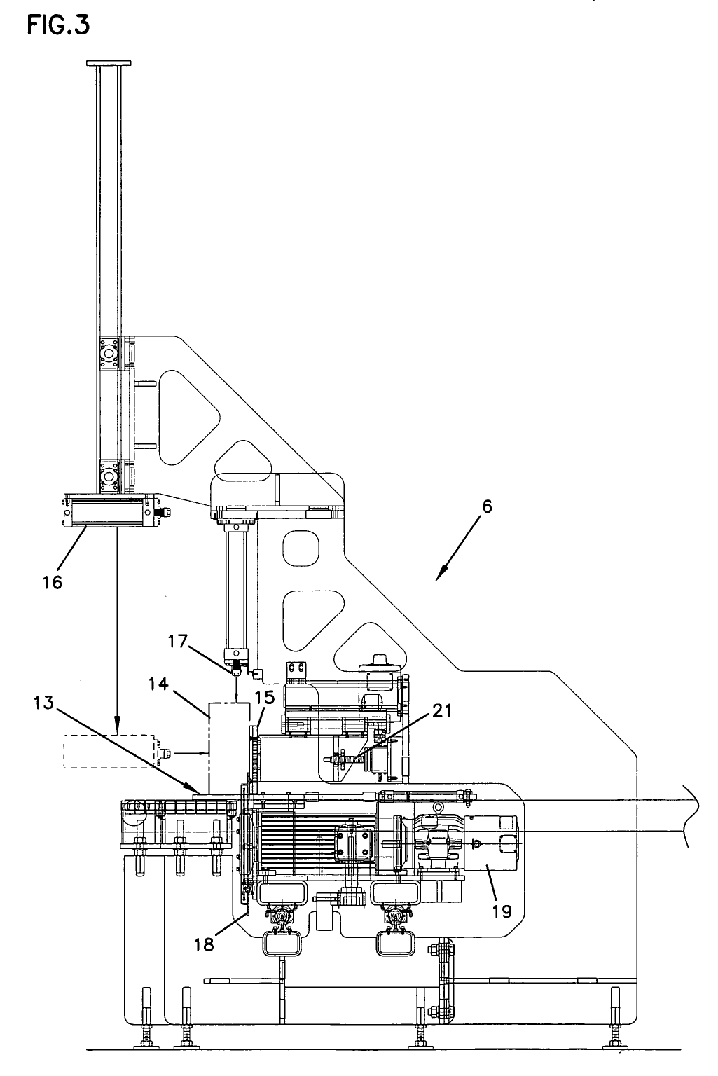

FIG. 3 is an enlarged end view of groove cutting machine 6 taken from the right side. Cutting machine 6 includes a horizontal table 13 on which a stone block 14 is placed against a vertical backing plate or gauge fence 15. A pneumatic actuator 16 can be moved downwardly into the phantom position shown and the actuator extended to the right to hold block 14 against plate 15. Another actuator or multiple actuators 17 can be extended downwardly to hold block 14 against table 13. The combination of actuators holds the block 14 securely in place during a subsequent cutting operation. A rotating diamond-tipped circular saw 18 driven by a motor assembly 19 is then moved along a track in a direction from front to back as shown in FIG. 3, and from right to left as shown in FIG. 1, to cut a groove about 1 or 1.5 inches deep in the bottom edge of block 14 spaced from and parallel to the face of block 14 adjacent backing plate 15. After the groove is cut along the entire bottom surface of block 14 from end to end, the actuators 16 and 17 are released and the machine automatically moves the block onto conveyer 10 to carry the block to roller conveyer 11. Backing plate 15 is adjustable with mechanism 21 to change the thickness of the resulting thin stone.

As shown in FIG. 3, groove cutting machine 6 cuts the groove from the lower side of stone 14. Cutting machine 6 could also be arranged to cut block 14 from the side, or from the top. The block could be turned, if necessary, to cooperate with the further block processing equipment downstream in the cutting process.

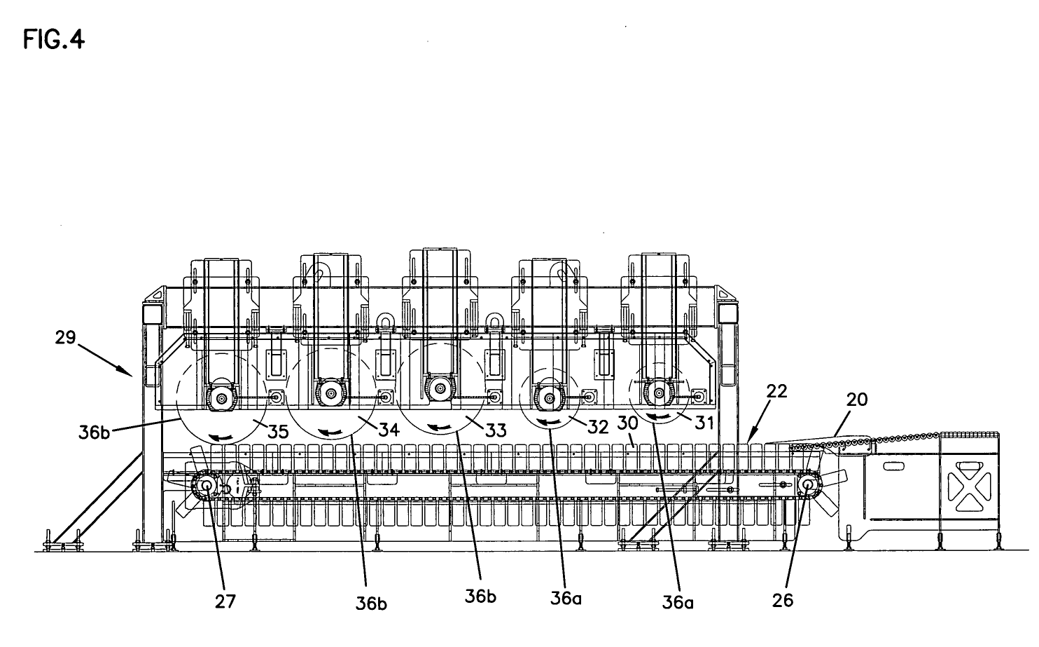

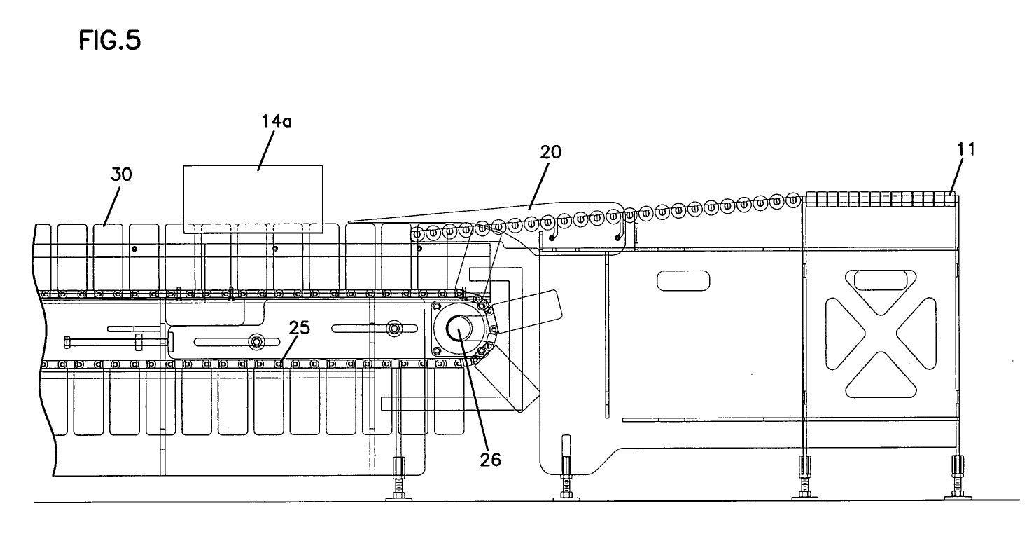

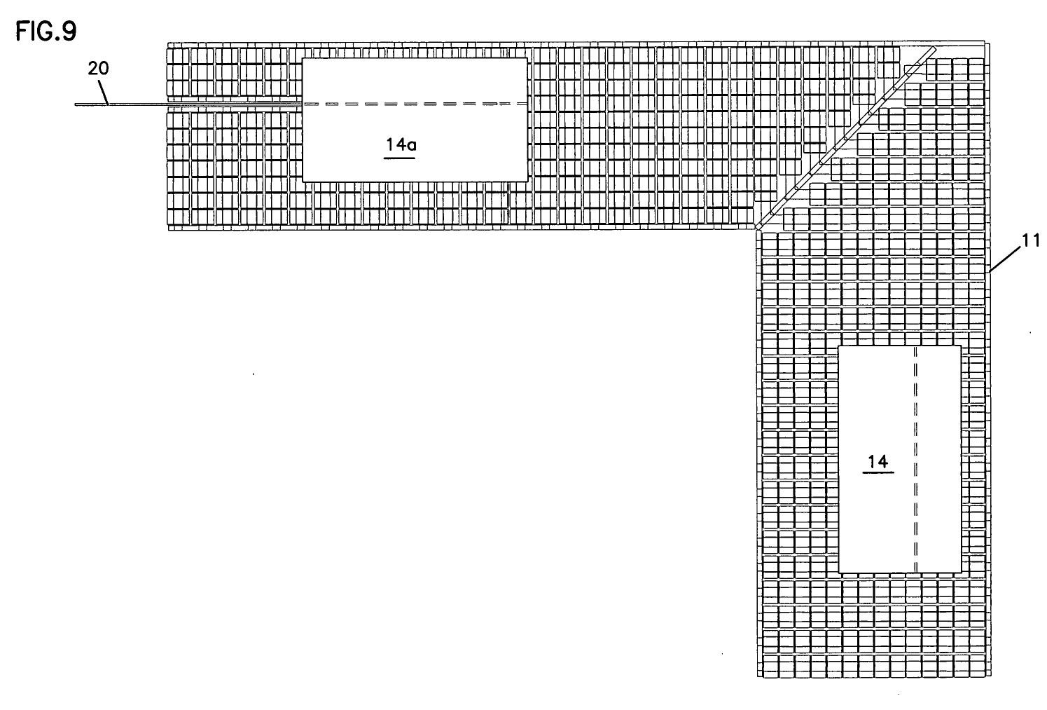

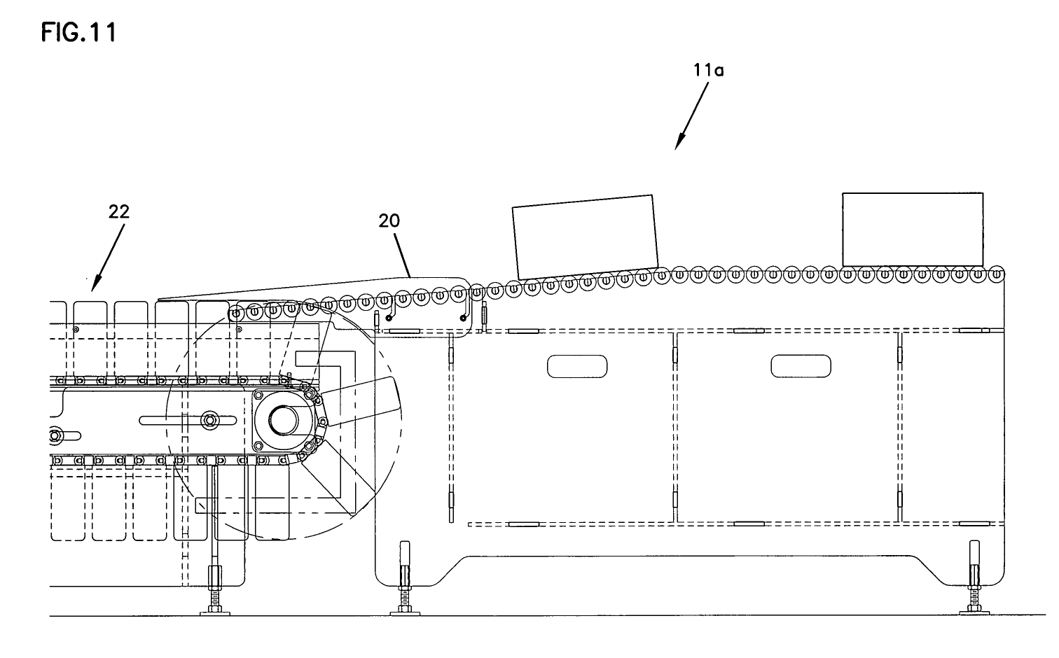

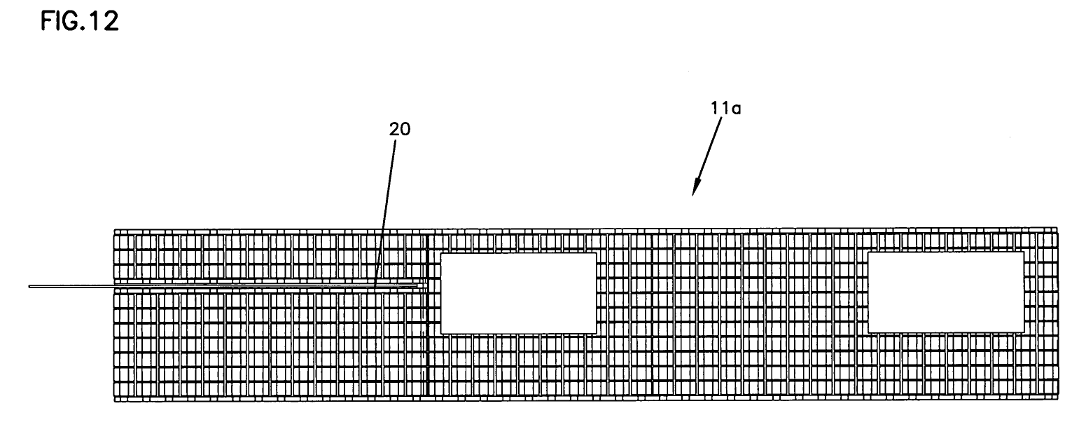

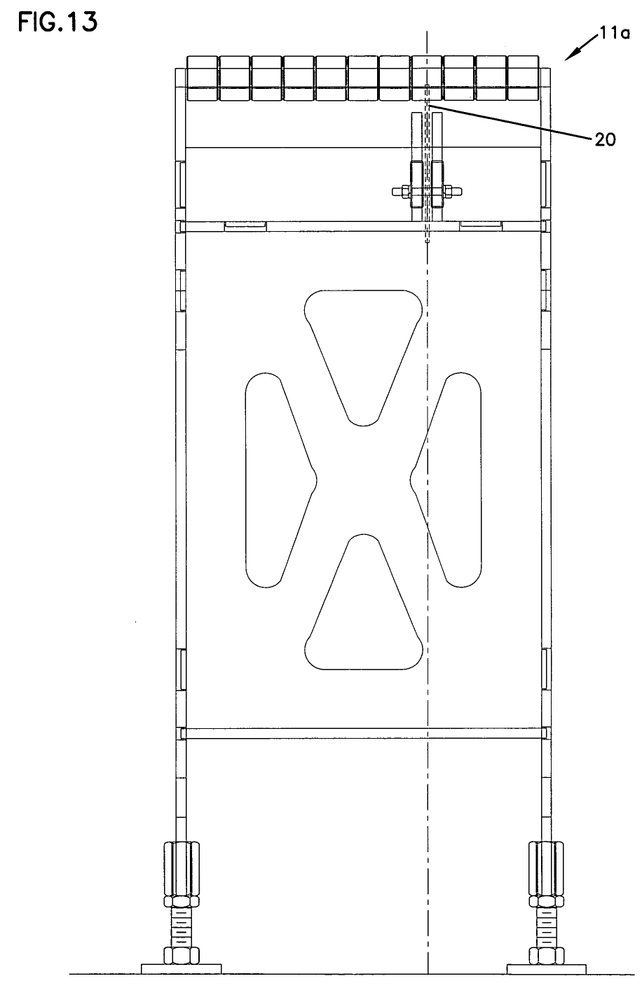

Referring to FIG. 9, two blocks 14 and 14a are shown disposed on the surface of roller conveyer 11, each block having a groove shown in phantom cut into the bottom surface of the block. The operator has moved block 14a so that it is on or in line with a guide blade 20 as further shown in FIGS. 4 and 5. Blade 20 is a flat steel plate positioned in a vertical plane having a thickness slightly smaller than the width of the groove cut in block 14a so that when placed over blade 20 it can be used to guide or align the block 14a onto the next conveyer 22. FIGS. 11-13 show the in-line roller conveyor 11a of FIG. 2 in greater detail. A similar guide blade 20 is provided.

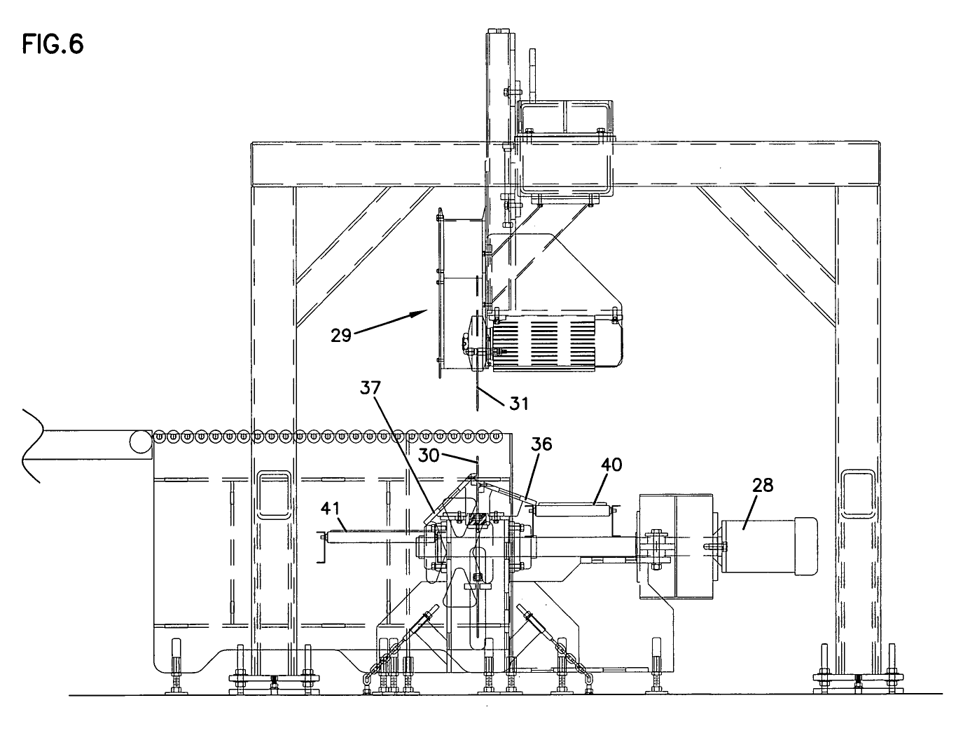

Referring to FIG. 4, the next conveyer 22 includes an endless conveyer chain 25 extending over a pair of spaced sprocket wheels 26 and 27 so that it can be driven by a motor assembly 28 as shown in FIG. 6 to cause the chain 25 to move in a counter-clockwise direction as shown in FIG. 4. A plurality of steel linear members or fins 30 are welded to chain 25 so that they move with the chain. In the preferred embodiment, the steel fins 30 are elongated rectangular members welded at one end to the chain 25 so that they extend in a vertical plane which also extends through the top and bottom runs of the chain 25. The fins 30 are spaced a short distance apart and the top edges are aligned horizontally. Guide plate or blade 20 lies in the same plane as the fins 30 and is generally the same thickness as the fins 30, that thickness being slightly smaller than the width of the groove cut in the bottom of block 14a. In FIG. 5, block 14a has been moved along plate 20 so that the bottom groove in block 14a is guided directly onto the plates 30, a plurality of which extend up into the bottom groove to hold the block 14a in place on the conveyer 22. The width of the guide groove cut in the bottom of block 14a is just slightly greater than the thickness of the fins 30 so that the block is held firmly in place as it moves along with the conveyer.

As shown in FIG. 4, positioned above the conveyer 22 is a cutting machine 29. As shown, machine 29 includes a series of rotating diamond-tipped stone cutting saws 31-35, the cutting tips or edges of which are positioned closer to the conveyer as viewed from right to left so that as a block moves along with the conveyer from right to left as shown in FIG. 4 the multiple blades cut sequentially deeper into the stone block until the final saw 35 cuts all of the way through, or nearly through, the block to the guide groove at which point the two pieces of the block fall off on different sides of the conveyer. As shown in FIG. 4, the edge of the circular saw 35 is almost touching the top edges of the fins 30. Because all of the circular saws including saw 35 lie in the same plane as fins 30, the cuts made by the saws are in the same plane as the guide groove of the block being cut so that the two grooves are joined at the end to split the block. More or fewer saw blades can be employed, depending on the maximum height of the stone to be cut, and on the desired rate of production. As will be discussed below, typically a small linear ridge extends across the cut face of the stone where the upper cut meets the lower cut, and the two stone pieces are formed.

Referring to FIG. 6, the saw 31 is shown positioned directly above fins 30, co-planar therewith. A water spray assembly is provided above all of the circular saws so that whenever cutting is taking place water is sprayed downwardly to capture and flush away the resulting dust in addition to helping cool the saws. Positioned on each side of the fins 30 along the length of the conveyer are fin guides/support members 36, 37 each of which slopes downwardly and away from the fins to drain off the dust laden water which continuously flows downwardly during the cutting process. As shown in FIGS. 1 and 6, belt conveyers 40 and 41 are positioned on opposite sides of the conveyer assembly to catch the block sections that fall off on both sides and convey them to operators who can direct the sections to an appropriate bin or pallet.

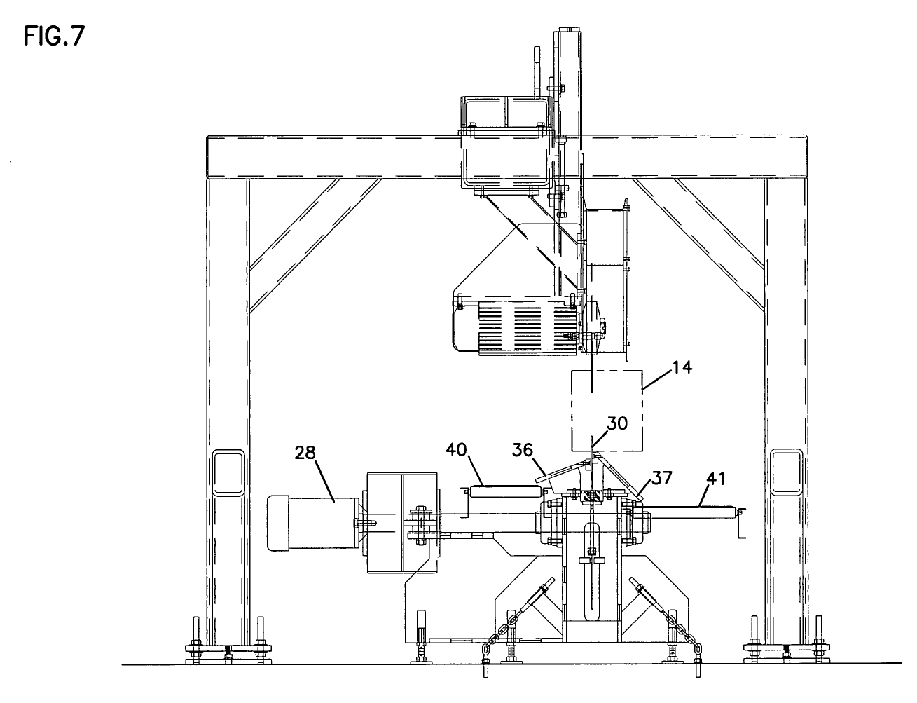

FIG. 7 discloses a block 14 positioned on the conveyer with the guide groove disposed over the fins 30 and with one of the circular saws cutting through the top of the block.

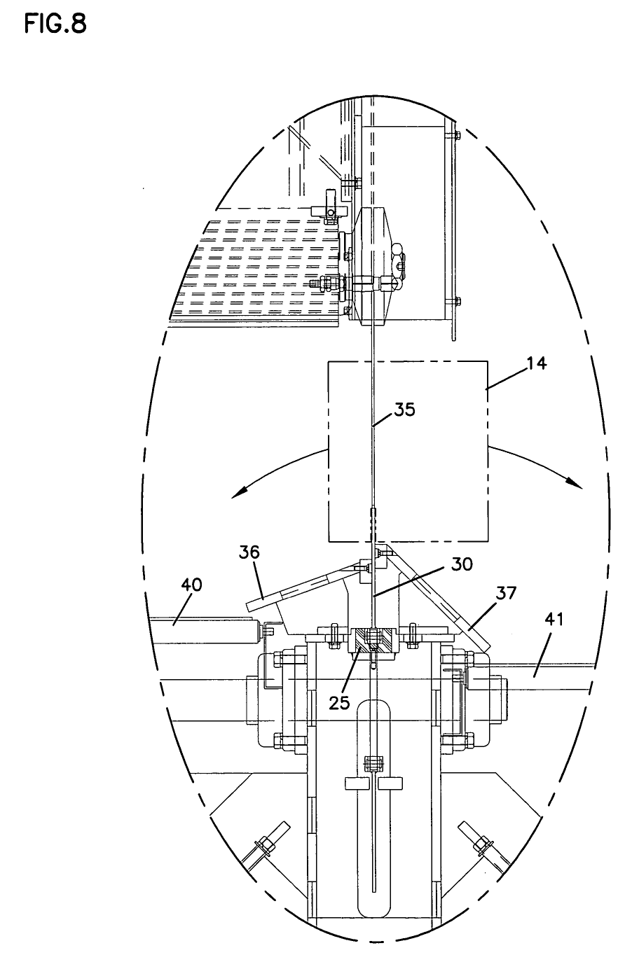

FIG. 8 discloses the same block positioned as it is being cut completely through by the final saw 35, with the arrows indicating that the two pieces fall in different directions after the block is cut. The final saw 35 preferably does not cut completely through to contact the fins 30. Instead, saw 35 comes very close to cutting all the way through. Then, the weight of the stone causes the thinned area to break, separating the stones. Alternatively, a wedge or other splitter device can be inserted into one of the cuts to cause the thinned area to break.

As viewed in FIG. 8, the smaller section or slice of the block 14 falling off to the left would be the desired piece. The larger piece of the block falling off to the right could be re-circulated and cut again to provide additional thin sections to be used in the building industry. The outer face of the larger piece of block 14 could also produce a useable piece of stone with a decorative face. The remaining inner section of the block would not have a large decorative face, but could be used for other purposes, such as landscaping. The desired section with a decorative face, falling off to the left in FIG. 8, can be cut to any desired thickness consistent with the integrity of the resulting section but typically the pieces are cut to about a 1-inch thickness. The resulting pieces, which are much thinner than the original blocks, weigh much less and occupy much less space during shipment thus reducing the cost of shipping, are much easier to handle and install at the construction site, and do not require special supporting footings under the wall to which they will be attached.

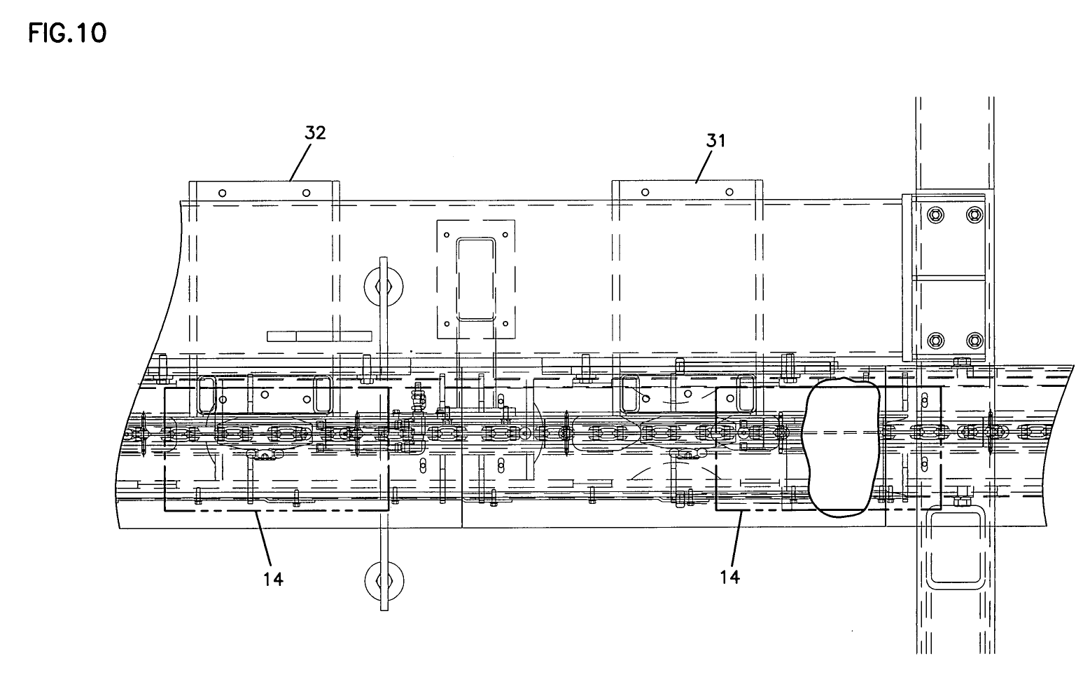

Referring again to FIG. 4, each saw blade 36a,b of each saw rotates in a direction which encourages secure engagement between fins 30 and each block of stone to be cut. The blades 36a,b push blocks 14 down onto fins 30. FIG. 10 shows two blocks 14 under saws.

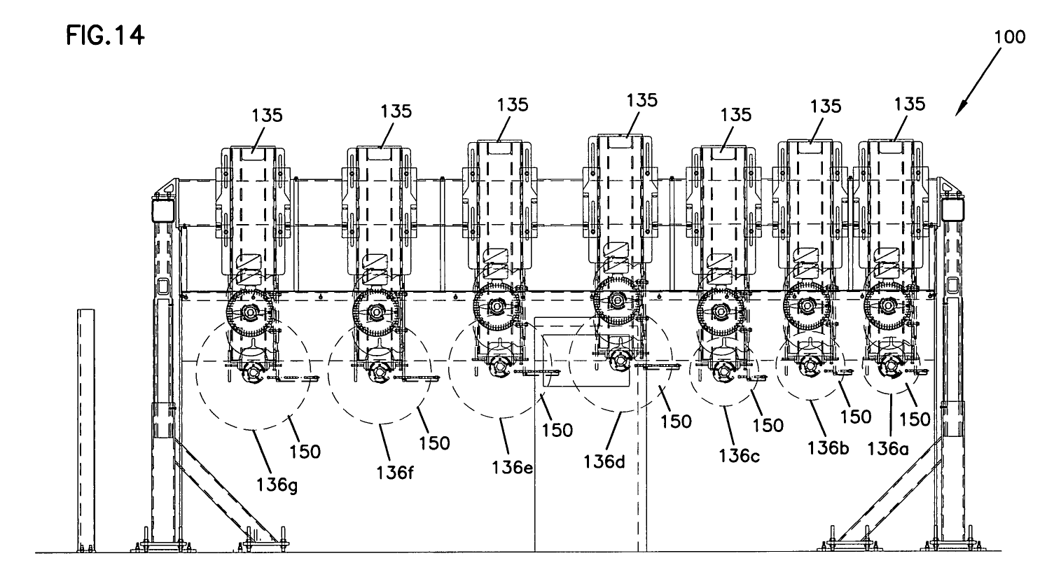

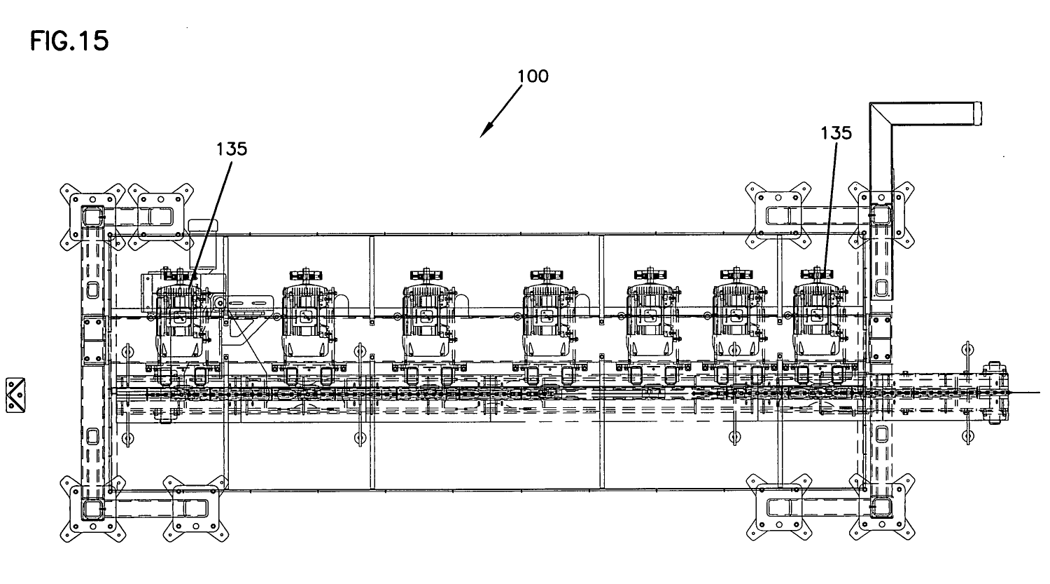

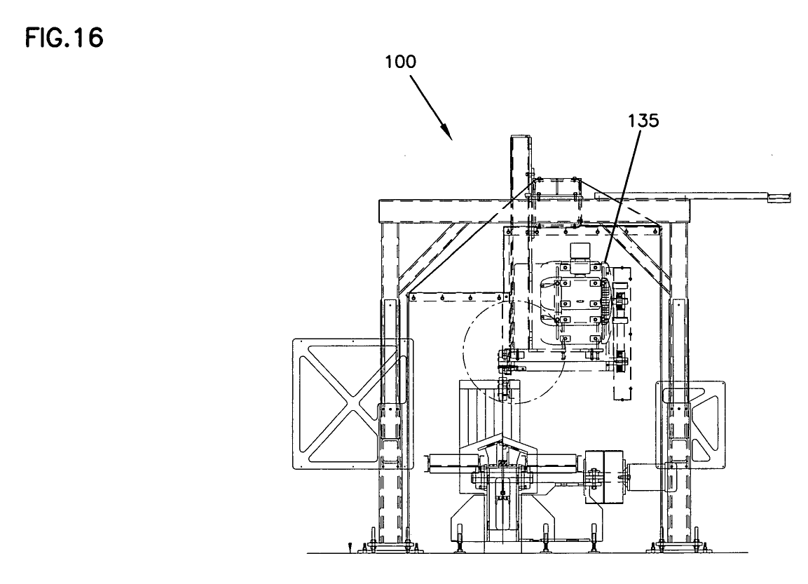

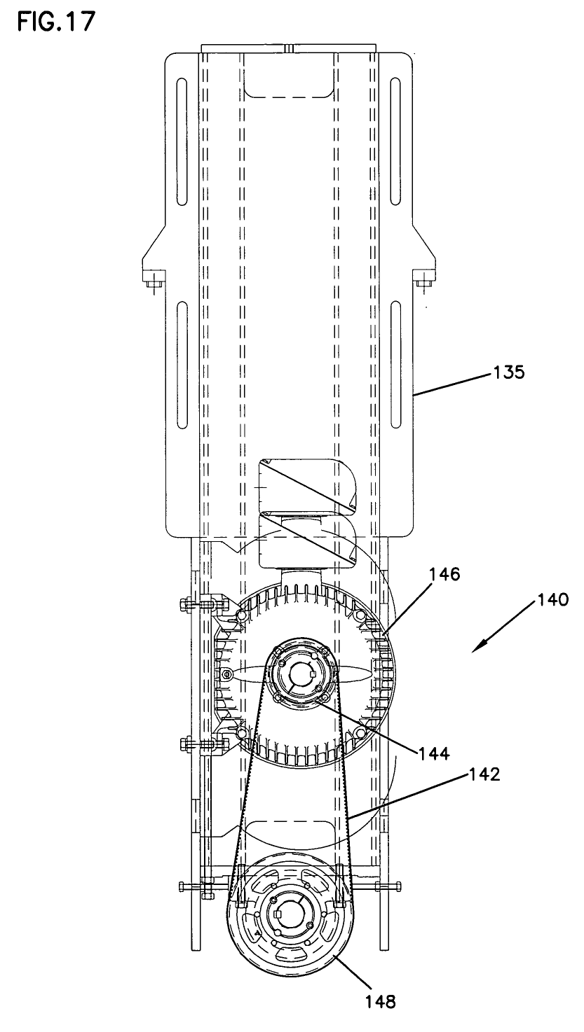

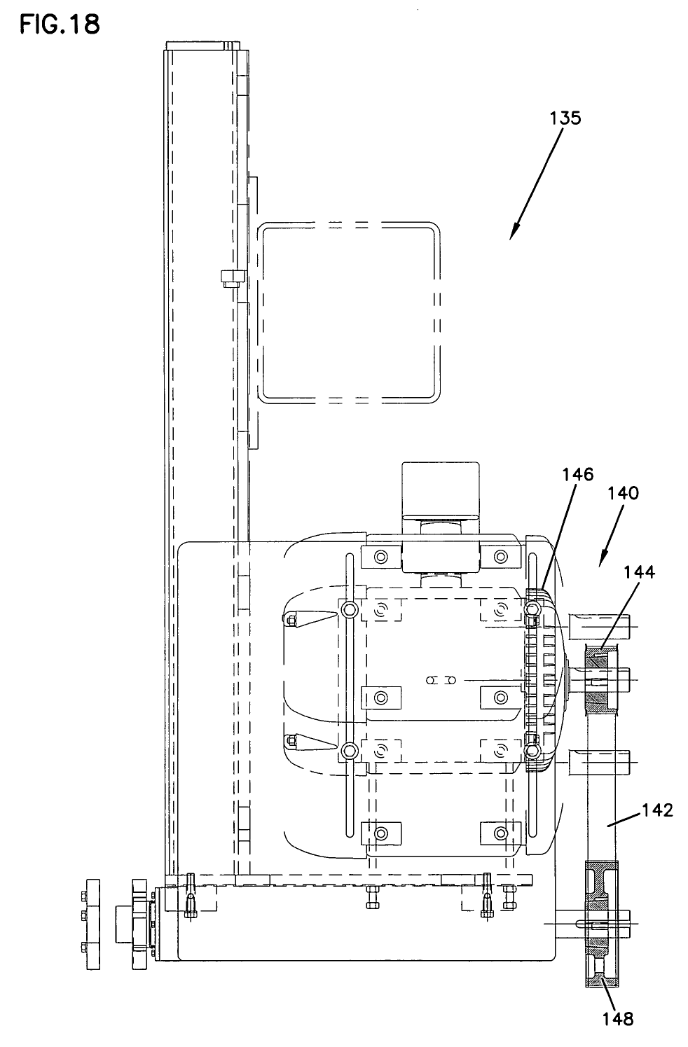

Referring now to FIGS. 14 through 18, an alternative stone cutting machine 100 is shown. Machine 100 is used instead of the saws 31-35 shown in FIG. 4. Instead of direct-drive arbor motors for each saw as shown in FIG. 4, a belt drive and arbor saw 135 is provided. Each saw 135 is adjustable vertically relative to the conveyor underneath the saws. Each saw blade 136a-g can have its speed adjusted by using different combinations of sprockets and belts to optimize the cutting speed for the different types of stones to be cut. Each of the seven saws 135 includes its own positive-drive belt and sprocket arrangement 140. Belt 142 is linked between the sprocket 144 of motor 146 and saw sprocket 148. Preferably, the speed of each saw blade at tip 150 is the same for each of saws 135.

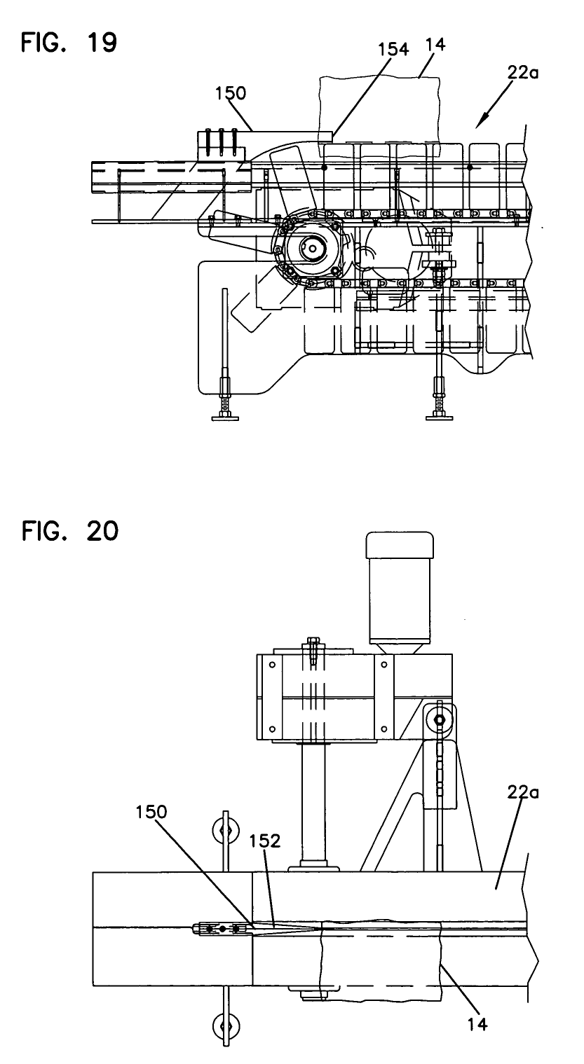

Referring to FIGS. 19 and 20, an alternative conveyor 22a is shown. Conveyor 22a includes fins 30 as described above. Mounted adjacent to the tips of fins 30 is a splitter device 150. In the illustrated example, splitter device 150 is in the form of a wedge 152. Wedge 152 includes a tip 154 positioned to align with the upper cut in stone 14, following the last cut of the cutting machines 29, 100. The wedge 152 helps split any stones that fail to break apart on their own. Tip 154 is shown partially received into the upper cut of stone 14.

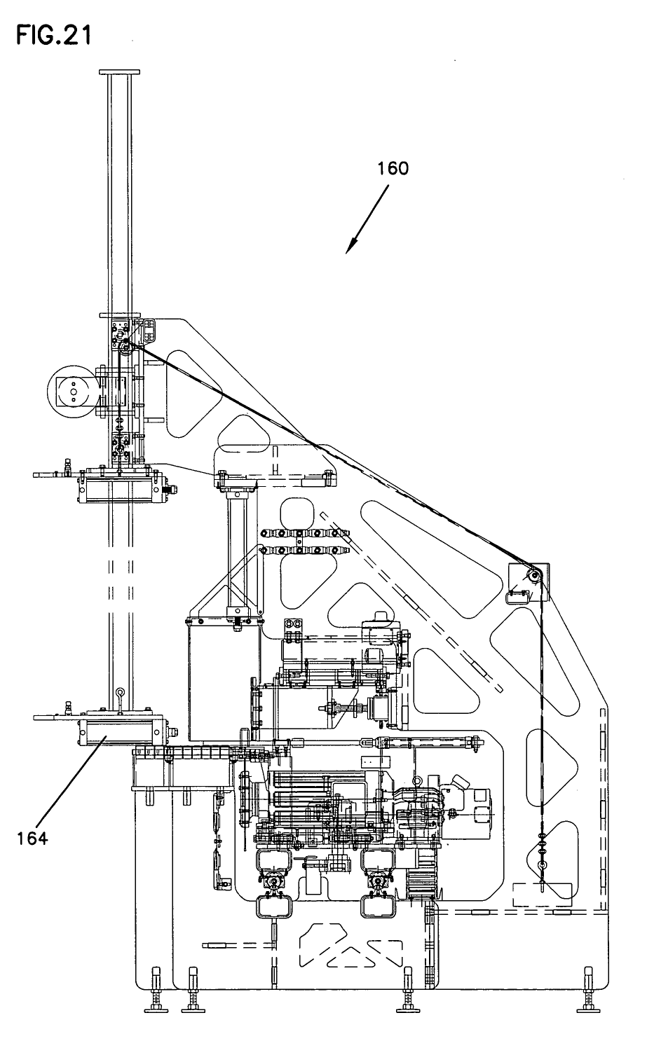

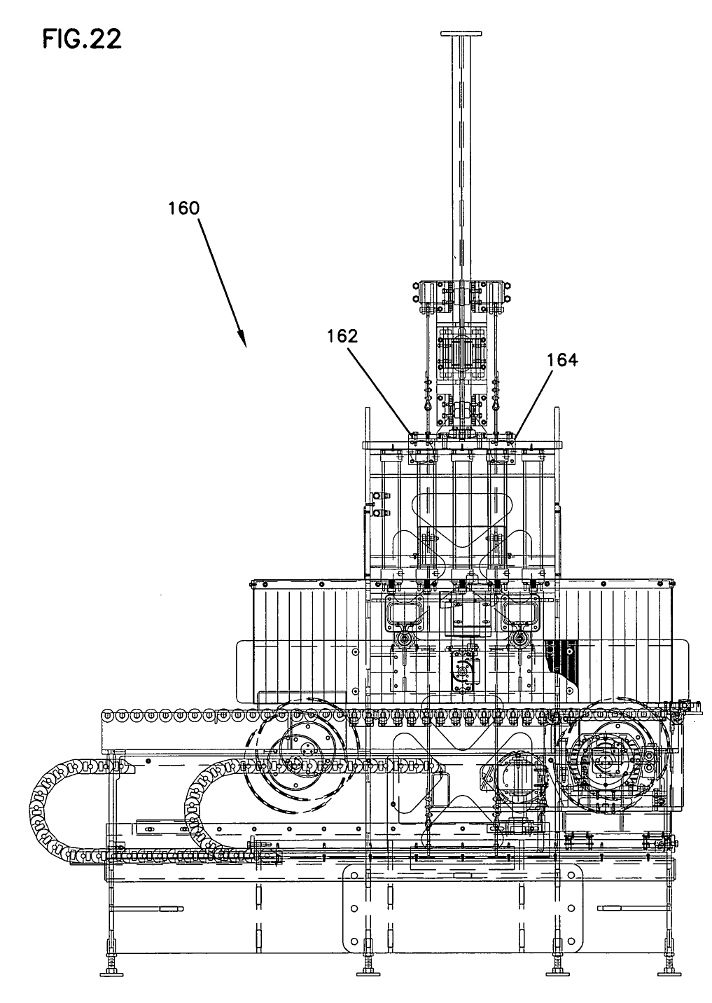

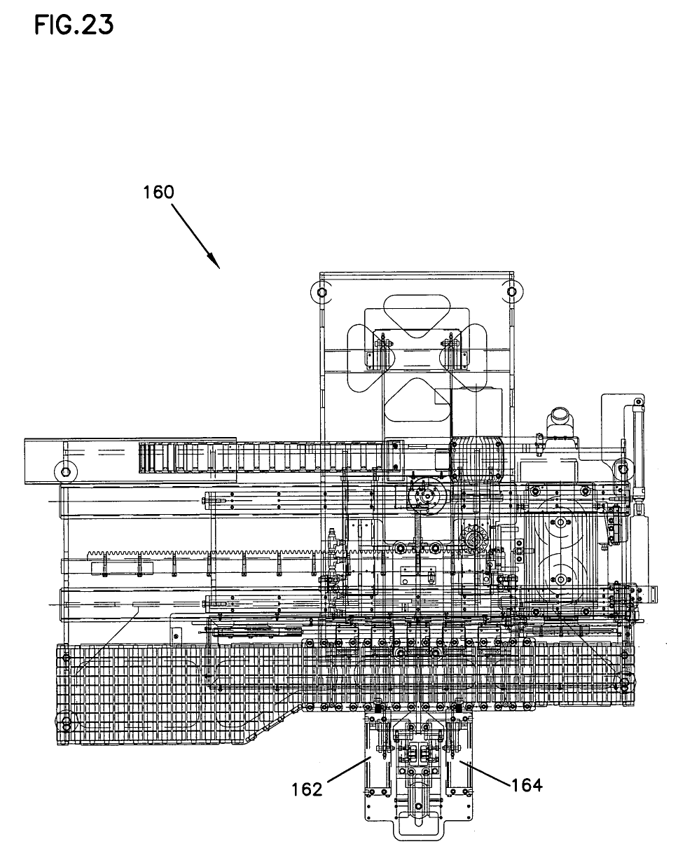

Referring now to FIGS. 21 through 23, a further alternative groove cutting machine 160 is shown. Machine 160 includes two horizontal clamping cylinders 162, 164. With two horizontal clamping cylinders, machine 160 can clamp and saw two stones at once, with a single linear cut. Machine 160 doubles the productivity of machines 6, 8. Referring now to FIG. 24, two of the machines 160 shown in FIGS. 21 through 23 are mounted in a back to back arrangement. The second machine 160b is a reverse image of the machine 160a. In this manner, a single operator can simultaneously operate both machines by sequentially clamping one or two stones in one machine and initiating the groove cutting step, and then unclamping the stone cut by the other machine, and then clamping one or two new stones and initiating the groove cutting step.

Various alternative embodiments are possible. For example, groove cutting machine 6 can be provided with a stationary saw, and a device to move blocks 14. Also, the final cutting machine could be provided with a moveable saw and stationary stones. For example, a chop saw could be used to make the final cut, using multiple passes of the moveable saw blade.

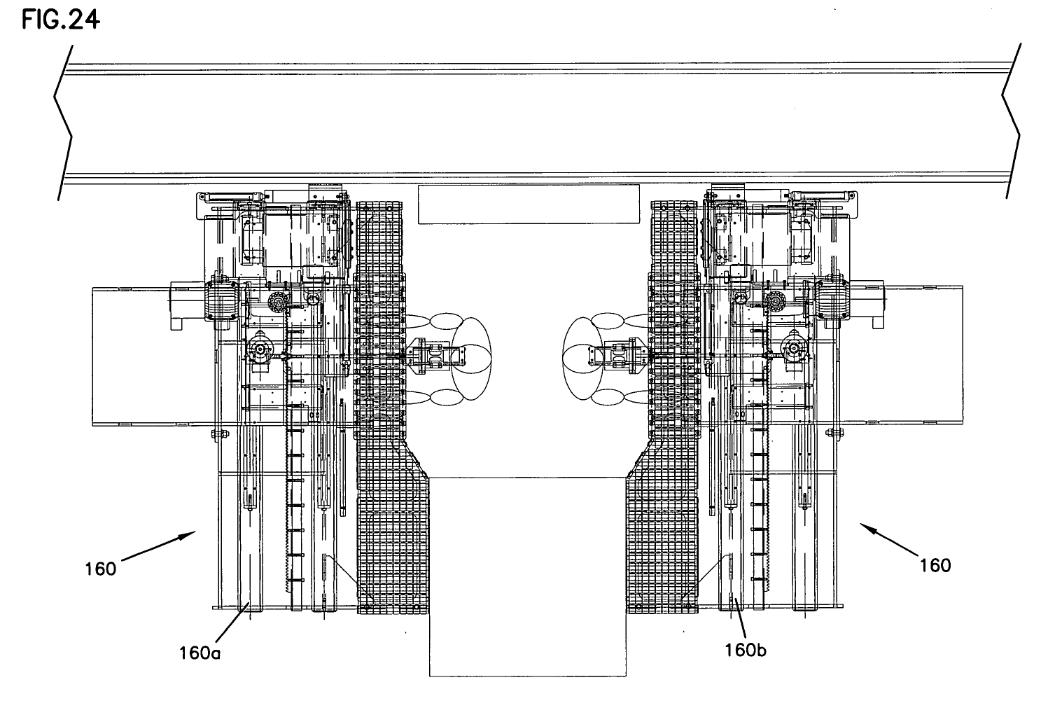

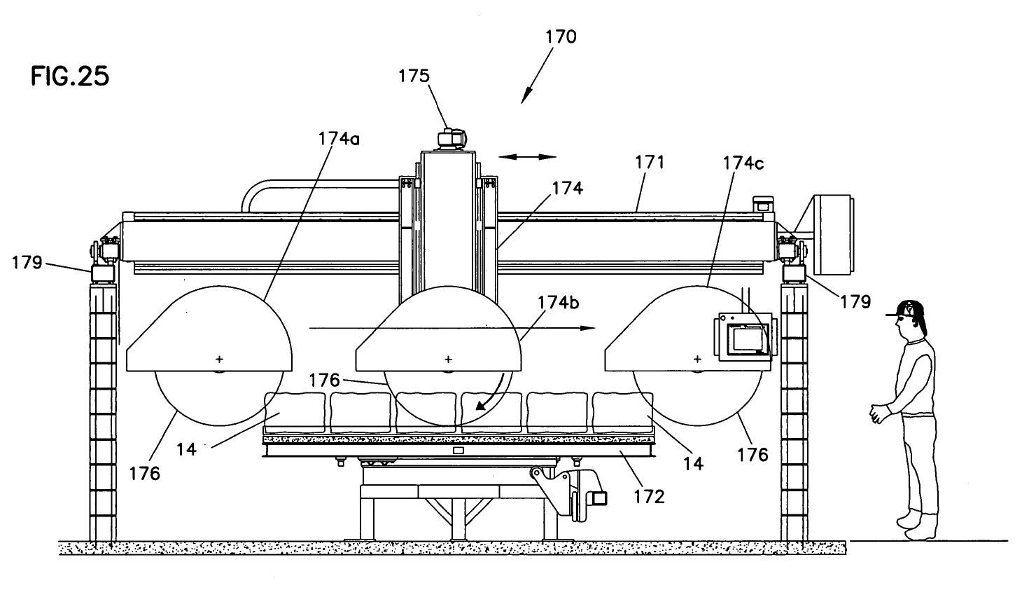

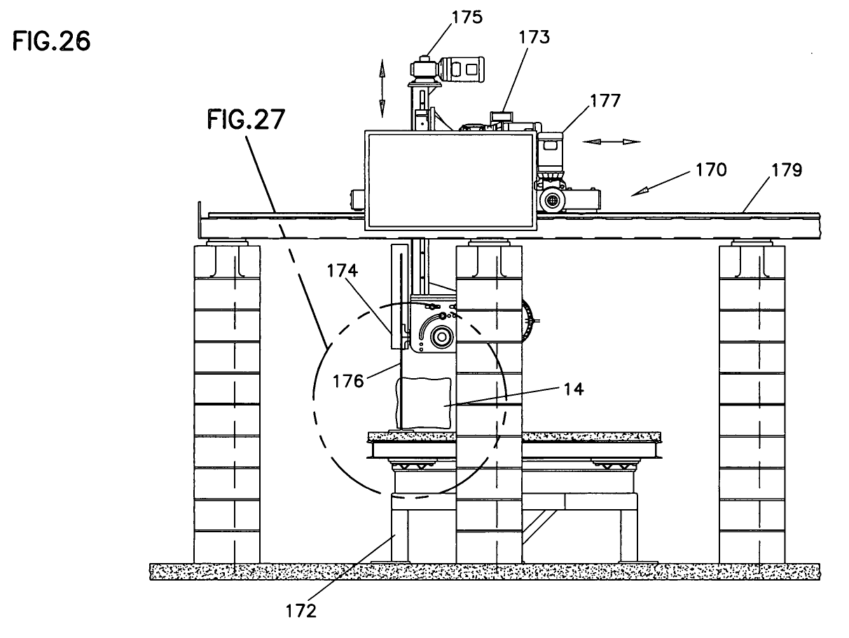

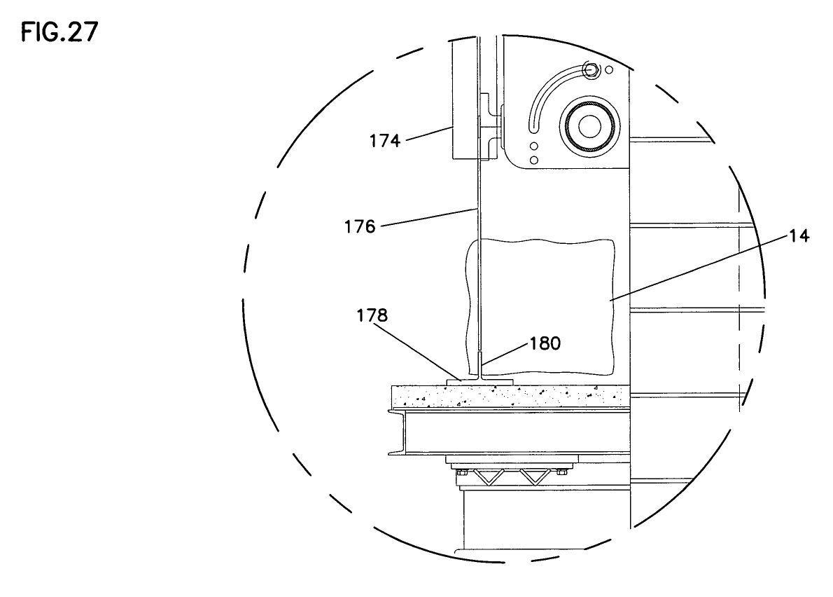

Referring now to FIGS. 25-27, an example of a moveable saw 170 is shown. Moveable saw 170 is a gantry saw where a motor 173 moves a saw 174 along an upper beam 171 relative to a work table 172 to cut blocks 14. Saw 174 moves linearly left to right in FIG. 25 from the positions shown at 174a,b,c. Saw 174 makes multiple passes to complete the cut, each pass at a greater depth for a saw blade 176 relative to blocks 14. An additional motor 175 moves saw 174 vertically. A further motor 177 moves saw 174 along cross-beams 179.

Table 172 includes a holding device 178 with an upright linear member or rail 180 for receipt of the lower groove of each block 14. Each lower groove can be cut as noted above before placement on linear member 180. During cutting by saw 174, each block is held by the engagement of the lower groove and linear member 180. In FIGS. 25-27, saw 174 cuts co-planar relative to the lower groove as noted above.

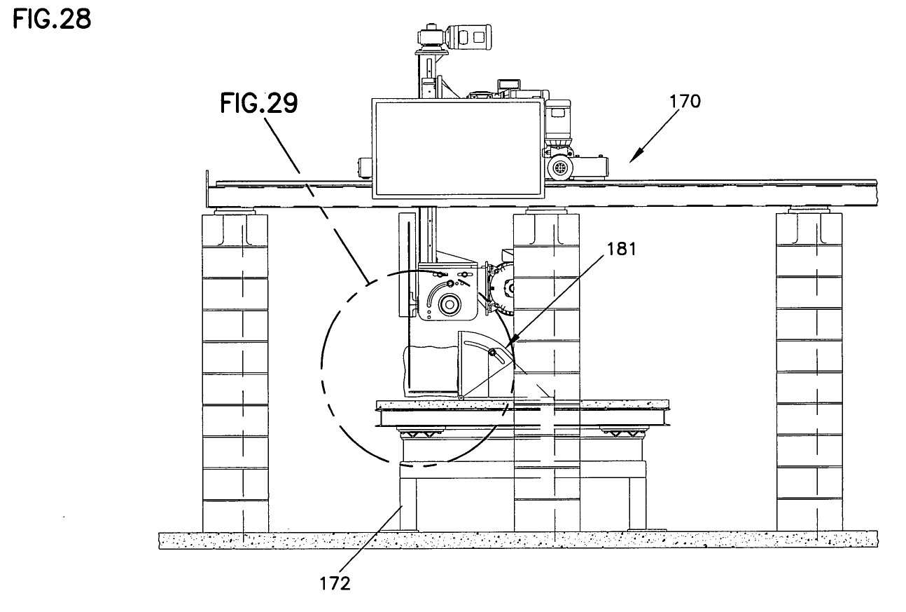

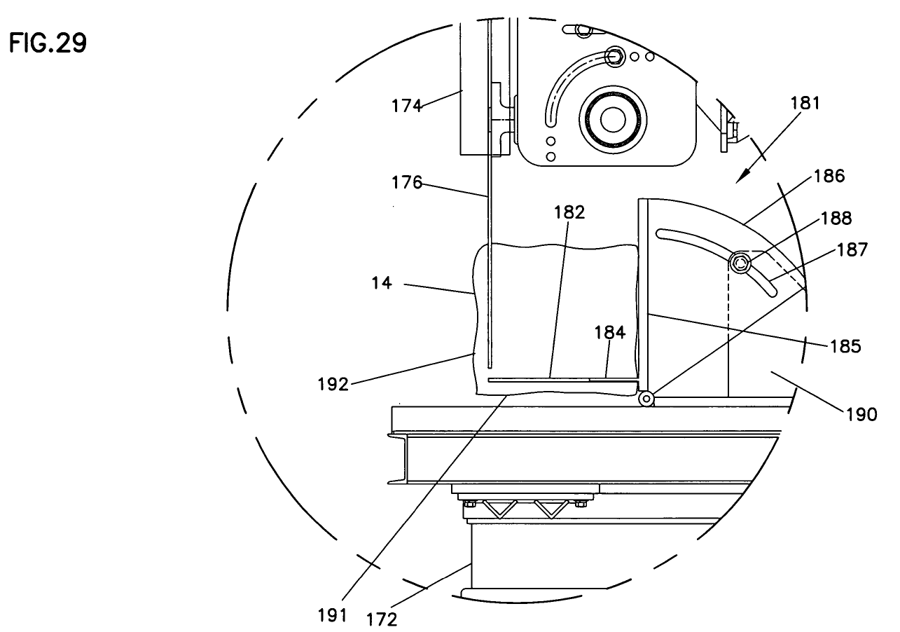

Referring now to FIGS. 28 and 29, an alternative holding device 181 is shown. Device 181 engages a groove 182 of block 14. Groove 182 receives a linear member 184. Groove 182 is at a 90° angle relative to saw blade 176. Linear member 184 extends from a base 185 of device 181. Base 185 can be mounted rigidly to work table 172. Alternatively, base 185 is moveable.

As shown, a first flange 186 extends from base 185 and is mounted to a second flange 190 which is affixed to work table 172. The mount between first and second flanges 186 and 190 is adjustable to cut at additional angles other than 90°. As shown, first flange 186 includes a curved slot 187 for receiving a fastener 188 mounted to second flange 190. When fastener 188 is loosened, first flange 186 can move through a range of angles provided by the length of curved slot 187. In this manner, different angles can be achieved as desired between groove 182 and saw blade 176 other than 90°.

One result of using the device 181 of FIGS. 28 and 29 is that corner stones may be cut having angled faces, such as 90°, 135° or other. Groove 182 is cut initially deeper that the grooves cut in the co-planar cuts noted above. The second cut by saw blade 176 completes the cutting of block 14 leaving a V-shaped or L-shaped stone having two angled faces 191, 192. As shown, the resulting thin stone is for a 90° corner.

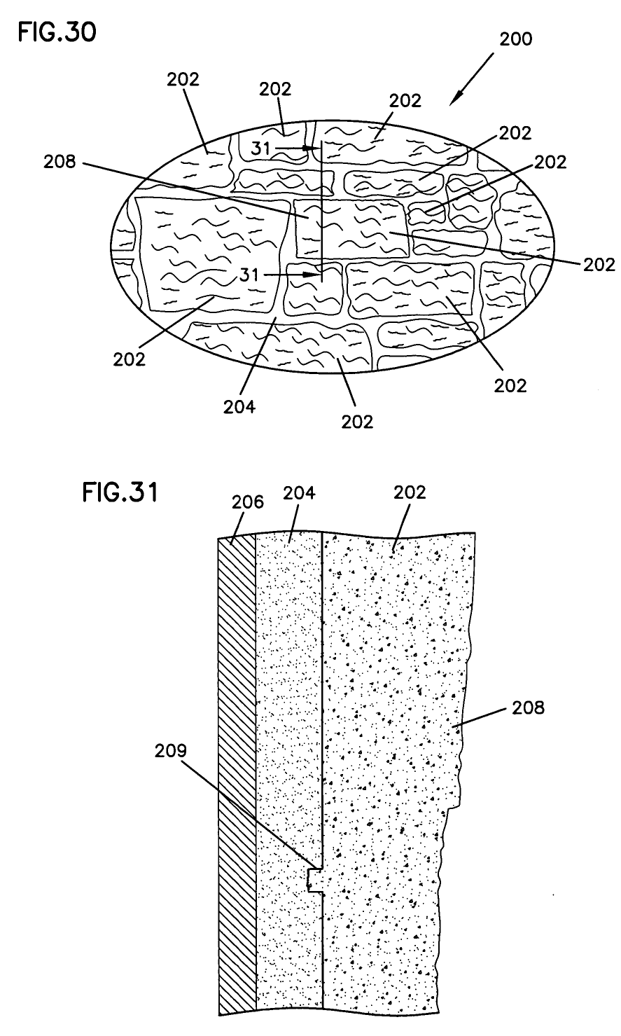

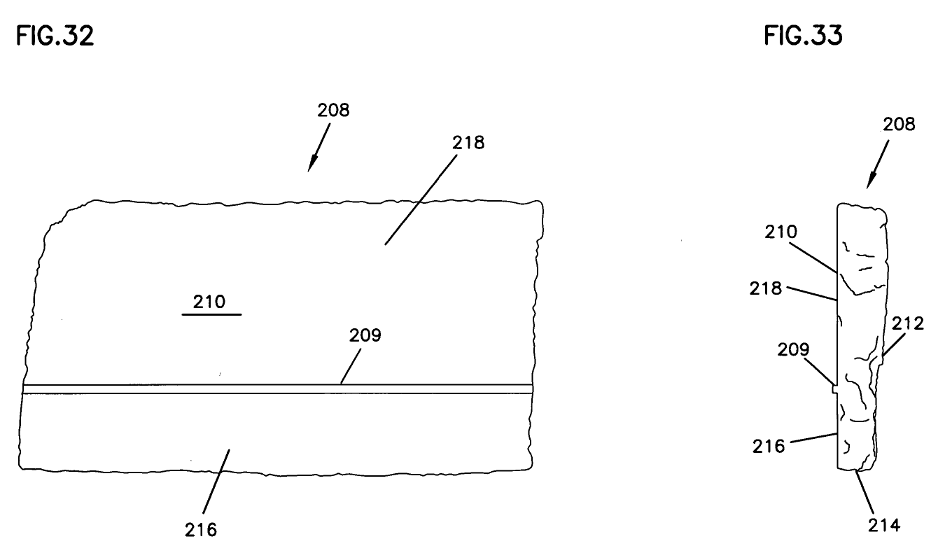

Referring now to FIGS. 30 and 31, an example wall 200 including various thin stones 202 and mortar 204. To construct the wall, a backing member 206 defines a vertical surface. Mortar 204 is applied to backing member 206. A plurality of stones 202 are pressed into the mortar. As shown in FIG. 31, stone 208 includes a protruding linear ridge 209. The linear ridge is shown in further detail in FIGS. 32 and 33. Such linear ridge 209 protrudes about ⅛ of an inch from the back surface 210 of stone 208. The linear ridge is about ⅛ to 3/16 inches wide. The linear ridge results when the upper cut from the final stone cutting machine almost reaches the groove cut by the groove cutting machine. The stone breaks at this very weakened point thereby causing the separation of the stone into two pieces. Front surface or face 212 includes the natural stone texture. Side 214 also includes the natural stone texture in the preferred embodiment. The natural stone textures are roughened, irregular surfaces, such as the result of stone quarrying or other stone collection and processing designed to result in the stones having non-planar surfaces. Back surface 210 is comprised of first planar surface 216 formed from the groove cutting step, and second planar surface 218 formed from the final cutting step. First and second planar surfaces 216, 218 are separated by ridge 209.

In the preferred embodiment, the backing member 206 can be a mesh or other suitable construction material positioned or formed on the wall structure to be covered with stones. The mortar is typical construction mortar and can include an acrylic adhesive. It is believed that the linear ridges provided on each of the thin stones improves the strength of the resulting wall and the bonding of each stone to the mortar. The linear ridge provides greater holding power and strength in the joint and the wall due to the extra strength added by the material and surface area of the ridge. Improved performance is believed to result, both in shear and pull off, due to the ridges.

The preferred apparatus and methods utilize a first cut for creating a groove in the blocks where the groove is engaged by a holding device while a second cut cuts in the same place from an opposite side of the block. The block breaks apart at the thinned area between the two cuts. Alternatively, the second cut can be in a different plane (parallel, transverse, or other), while the block is held by engagement of the groove. This alternative cutting approach may not be as efficient as the preferred approach since a full second cut is needed across the block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A stone cutting apparatus for cutting blocks of stone comprising:
a groove cutting device for cutting a groove in a first side of each block of stone along a first cutting plane;
a block cutting device for cutting each block of stone in a direction from an opposite side of the block opposite to the first side, the block cutting device cutting each block along a second cutting plane co-planar with the first cutting plane;
a block holder device including a linear member received in the groove of each block when each block is being cut by the block cutting device.

2. The stone cutting apparatus of claim 1, further comprising a conveyor for moving each block relative to the block cutting device, the linear member of the block holding device mounted to the conveyor.

3. The stone cutting apparatus of claim 2, wherein the conveyor includes a plurality of the linear members.

4. The stone cutting apparatus of claim 3, further comprising a block moving device for moving the blocks from the groove cutting device to the block cutting device.

5. The stone cutting apparatus of claim 4, wherein the block moving device includes a linear guide blade linearly aligned with the linear members of the conveyor.

6. The stone cutting apparatus of claim 5, further comprising:
a first cut block receiving device for receiving a first cut block portion;
a second cut block receiving device for receiving a second cut block portion;
wherein each of the first and second cut block portions falls under gravity from the block cutting device and the block holder device once the cut from block cutting device reaches the groove.

7. The stone cutting apparatus of claim 6, further comprising a block splitter positioned for receipt in the cut made by the block cutting device.

8. The stone cutting apparatus of claim 6, wherein the block cutting device includes a plurality of blades aligned in a common plane, a first blade of the plurality of blades including a cutting edge spaced from the block holder device a first distance, and the cutting edge of each successive blade spaced from the block holder device a distance less than the first distance, and less than any preceding blade, wherein the cutting edge of each blade rotates in same direction of movement of the conveyor.

9. The stone cutting apparatus of claim 8, wherein the block cutting device includes a control device for controlling the speed of each blade, wherein a tip speed of each blade is equal between all of the blades.

10. The stone cutting apparatus of claim 9, wherein the control device of the block cutting device includes a belt and sprocket for each blade.

11. The stone cutting apparatus of claim 1, wherein the groove cutting device includes a gauge fence for engaging a front of the block, and a clamp for holding the block during cutting of the groove.

12. The stone cutting apparatus of claim 11, wherein the groove cutting device include a second clamp for holding a second block of stone, wherein the groove can be formed in two stones with a single linear cut of the groove cutting device.

13. The stone cutting apparatus of claim 1, further comprising a block moving device for moving the blocks from the groove cutting device to the block cutting device.

14. The stone cutting apparatus of claim 1, further comprising:
a first cut block receiving device for receiving a first cut block portion;
a second cut block receiving device for receiving a second cut block portion;
wherein each of the first and second cut block portions falls under gravity from the block cutting device and the block holder device once the cut from the block cutting device reaches the groove.

15. The stone cutting apparatus of claim 1, wherein the block cutting device includes a plurality of blades aligned in a common plane, a first blade of the plurality of blades spaced from the block holder device a first distance, and each successive blade spaced from the block holder device a distance less than the first distance, and less than any preceding blade.

16. The stone cutting apparatus of claim 15, wherein the block cutting device includes a control device for controlling the speed of each blade, wherein a tip speed of each blade is equal between all of the blades.

17. The stone cutting apparatus of claim 16, wherein the control device of the block cutting device includes a belt and sprocket for each blade.

18. The stone cutting apparatus of claim 1, further comprising a block splitter positioned for receipt in the cut made by the block cutting device.

19. The stone cutting apparatus of claim 1, wherein the block cutting device includes a moveable saw which moves linearly relative to the block holder device.

20. A stone cutting apparatus for cutting blocks of stone comprising:
first means for cutting a groove in each block of stone;
means for holding each block of stone by engaging the groove;
second means for cutting each block of stone into two pieces while the means for holding holds the block of stone.

21. The stone cutting apparatus of claim 20, wherein the second means for cutting cuts each block of stone in the same plane as the groove.

22. The stone cutting apparatus of claim 21, wherein the second means for cutting includes at least one cutting blade, and further comprising means for moving each block of stone relative to the at least one cutting blade.

23. The stone cutting apparatus of claim 22, wherein the means for moving includes a conveyor, and wherein the means for holding includes a plurality of linear members mounted to the conveyor, at least one of the linear members received in the groove of each block of stone to hold the respective blocks.

24. The stone cutting apparatus of claim 21, wherein the second means for cutting includes at least one cutting blade, and a mechanism for moving the cutting blade linearly relative to each block of stone.

25. The stone cutting apparatus of claim 20, further comprising means for moving each block of stone from the first means for cutting to the means for holding.

26. The stone cutting apparatus of claim 20, further comprising means for catching the cut portions of each block of stone after being cut by the second means for cutting.

27. The stone cutting apparatus of claim 20, further comprising block splitting means adjacent to the second means for splitting the block in the area between the groove and the cut from the second means for cutting.

28. The stone cutting apparatus of claim 20, wherein the second means for cutting includes at least one cutting blade, and a mechanism for moving the cutting blade linearly relative to each block of stone.

29. A method for cutting blocks of stone, comprising the steps of:
cutting a groove in each block of stone;
engaging the groove with a linear member to hold the block of stone;
cutting each of the held blocks of stone from an opposite side of the stone, wherein the cut from the opposite side meets the groove to separate the block into two pieces.

30. The method of claim 29, further comprising the step of moving the linear member relative to a cutting device which cuts each of the held blocks, wherein the cutting device includes a plurality of rotating cutting blades, wherein a first blade has an outer edge positioned at a first distance from the linear member, and each additional cutting blade has the respective outer edge closer to the linear member as the linear member is moved relative to the cutting device.

31. The method of claim 30, further comprising the step of moving the blocks from a first station which cuts the grooves to the cutting device, and further comprising providing a guide blade, and aligning each groove with the linear member before each block reaches the cutting device.

32. The method of claim 29, further comprising the steps of cutting a further groove in one piece of the two pieces of the cut block, wherein the one piece is engaged with the linear member, and the one piece is further cut from an opposite side, wherein the further cut from the opposite side meets the further groove to separate the one piece into two further pieces.

33. The method of claim 29, further comprising splitting the held blocks of stone after the cutting step from the opposite side.

34. The method of claim 29, further comprising the step of moving a cutting device relative to each of the held blocks to cut the held blocks from the opposite side.

35. A thin stone for use with mortar for covering a wall comprising:
a rock body made from natural stone and having a front, an opposite facing back, and a side between the front and the back;
a protruding linear ridge extending from the back of the rock body.

36. The thin stone of claim 35, where in the linear ridge is formed by making a first planar cut from one side of the rock body, and a second planar cut from an opposite side of the rock body, wherein the first and second planar cuts each define planes which are coplanar with each other.

37. A wall comprising:
a.) a backing defining a vertical surface;
b.) a layer of mortar held by the backing;
c.) a plurality of thin stones each including:
i.) a rock body made from natural stone and having a front, an opposite facing back, and a side between the front and the back;
ii.) a protruding linear ridge extending from the back of the rock body,
wherein the backs of each rock body are held by the mortar with the linear ridges protruding into the mortar.

38. The wall of claim 37, wherein the linear ridge of each thin stone is formed by making a first planar cut from one side of the rock body, and a second planar cut from an opposite side of the rock body, wherein the first and second planar cuts each define planes which are coplanar with each other.

39. A method of forming a wall comprising of steps of:
providing a backing defining a vertical surface;
applying mortar to the backing;
pressing a plurality of natural stones into the mortar, wherein each natural stone includes a projecting linear ridge pressed into the mortar.

40. The method of claim 39, wherein the linear ridge of each natural stone is formed by making a first planar cut into the natural stone, followed by a second planar cut into the natural from an opposite wherein each of the planar cuts are coplanar.

41. A stone cutting apparatus for cutting a block of stone comprising:
a groove cutting device for cutting a groove in a first side of the block of stone along a first cutting plane;
a block cutting device for cutting the block of stone in a direction from another side of the block;
a block holder device including a projecting member received in the groove of the block when the block is being cut by the block cutting device.

42. The stone cutting apparatus of claim 41, further comprising a conveyor for moving the block relative to the block cutting device, the projecting member of the block holding device mounted to the conveyor.

43. The stone cutting apparatus of claim 41, further comprising a mechanism for moving the block cutting device relative to the block holder device.

44. The stone cutting apparatus of claim 41, wherein the block holder device includes a movable mount wherein the projecting member is positionable at a plurality of angles relative to the block cutting device.

45. A method for cutting a block of stone, comprising the steps of:
cutting a groove in a side of the block of stone;
engaging the block of stone with a projecting member received in the groove;
cutting the block of stone from another side of the block of stone while the block of stone is held by the projecting member.
